(19) United States
(12) Patent Application Publication
(10) Pub. No.: US 2025/0356370 A1
(43) Pub. Date: Nov. 20, 2025

(54) METHODS FOR GENERATING AND SELECTING A DIGITAL PASSPORT RELATING TO AN APPLICATION INTENDED TO BE DEPLOYED IN AT LEAST ONE COMPUTER ENTITY, CORRESPONDING DEVICES AND COMPUTER PROGRAMS

(71) Applicant: Orange, Issy-les-Moulineaux (FR)

(72) Inventors: Nathalie Labidurie, CHATILLON (FR); Emile Stephan, CHATILLON (FR); Romuald Corbel, CHATILLON (FR)

(21) Appl. No.: 19/210,255

(22) Filed: May 16, 2025

(30) Foreign Application Priority Data
May 17, 2024 (FR) 2405086

(51) Int. Cl. G06Q 30/018; G06Q 10/0639

(52) U.S. Cl. CPC G06Q 30/018; G06Q 10/0639

(57) ABSTRACT

A method is described for generating, by an electronic device, at least one digital passport relating to an application intended to be deployed in at least one computer entity, the digital passport including at least one entry including information relating to at least one development environment in which the application is developed.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Technical Field

The disclosed technology belongs to the general field of the development and production of applications and/or software.

It more particularly concerns the generation of a digital passport relating to an application intended to be deployed as well as the instantiation of a deployment environment for the application based on the information contained in the digital passport of the application.

### Description of the Related Art

In a context of growing concern about the limited resources of the planet, the sustainable management of consumer products is becoming a major issue.

Indeed, consumers, businesses, and regulators are increasingly demanding transparency about the products they use, in particular regarding their origin, composition, sustainability, safety, energy consumption, recyclability and environmental impact.

In order to meet this information request, some organizations are seeking to promote a circular economy and a transition to a more sustainable economy.

The “Product Passport” initiative of the European Commission is part of this context. More specifically, this initiative aims to improve the traceability of the products put on the market on the territory of the European Union from their design to their end of life by providing transparent and reliable information on their origin, composition, environmental impact and sustainability.

For their part, telecommunications network operators have adopted several strategies to reduce their ecological footprint and promote the sustainability of their infrastructures and the services they offer, in particular by reducing the energy consumption of their networks, by integrating eco-design principles into the development of the equipment and services, aimed at reducing the resource consumption, the waste production and the greenhouse gas emissions throughout the life cycle of these products, or by also setting up electronic waste recycling and management programs to recover, reuse and recycle the obsolete or end-of-life equipment, thus helping to reduce the accumulation of electronic waste and preserve the natural resources.

While the telecommunications operators, like other players in the digital technology sector such as service providers, are capable of meeting the expectations of their users and the regulators in terms of transparency on the equipment they use because data are provided to them by the manufacturers of this equipment, it is not the same for the software they develop or implement as part of their activities.

### SUMMARY

The disclosed technology aims to overcome all or part of the drawbacks of other approaches, in particular those set out above, by proposing a solution that makes it possible to provide, for a software or an application, or a component of an application or a microservice participating in the application, transparent and reliable information regarding their origin, their composition, their environmental cost, their sustainability, their reusability in other environments in which it can be executed.

To this end, and according to a first aspect, embodiments of the disclosed technology concern a method for generating, by an electronic device, at least one digital passport relating to an application intended to be deployed in at least one computer entity, said digital passport comprising at least one entry comprising information relating to at least one environment, called development environment, in which said application is developed.

Correspondingly, embodiments of the disclosed technology concern an electronic device comprising:
a module for generating at least one digital passport relating to an application intended to be deployed in at least one computer entity, said digital passport comprising at least one entry comprising information relating to at least one environment, called development environment, in which said application is developed,
a transmission module configured to transmit said digital passport to at least one node contributing to a shared register in which information relating to a plurality of digital passports relating to applications intended to be deployed in at least one other computer entity is stored.

The present solution proposes to generate, for each version of a given application or software, a digital passport comprising information relating to the environment in which it was developed.

A development environment of a software or of an application is a set of tools, hardware and/or software resources, used by developers to generate, test and debug the software or the application.

Such a development environment generally comprises: code editors, code compilers/interpreters, version managers, test tools, or debuggers. Finally, a development environment comprises servers, virtual machines, Docker or Kubernetes containers, etc., used to execute the application under development.

Such information relating to a development environment belongs for example to a group comprising at least:
a value of the electricity consumption relating to the development of the application,
a value representative of the quantity of carbon generated by the development of the application,
a value representative of the quantity of water used during the manufacture and/or the cooling and/or the recycling of the hardware components used during the development of the application,
a list of metals used during the manufacture of the hardware components used during the development of the application,
a quantity of metals used during the manufacture of the hardware components used during the development of the application,
a percentage of recycled metal for at least one of the metals used during the manufacture of said hardware components,
an identifier of at least one hardware component used during the development of the application,
an identifier of a version of at least one operating system of at least one hardware component used during the development of the application,
an identifier of at least one transport protocol supported by the application,
an identifier of a version of a compute node management system executing the application.

This information relating to a development environment may further comprise data relating to the commissioning of some equipment, or an estimated lifespan thereof, etc.

Such information relating to a development environment is obtained from at least one monitoring entity of said at least one development environment.

In particular implementations, the information relating to said at least one development environment is obtained in response to the transmission, by said electronic device, of a request for information relating to a development environment.

In order to best account for the environmental impact of the application, such a digital passport is updated throughout the development of the application.

For this purpose, the information relating to said at least one development environment may be obtained periodically, this is for example the case of the value of the electricity consumption relating to the development of the application, which may evolve over time, or asynchronously. Information such as the quantity of metals used during the manufacture of the hardware components used during the development of the application or an identifier of at least one transport protocol supported by the application for example, only evolving when a change of equipment or of transport protocol occurs, can be transmitted asynchronously.

When they concern the same version of an application, the new information relating to said at least one development environment obtained is stored in said at least one entry of the corresponding digital passport.

In the context of continuous integration/continuous delivery or CI/CD of the applications, the update of the digital passport allows for accurate and comprehensive documentation of the various updates and changes made to the application and to the environment in which it is developed throughout the development phase.

Continuous integration (CI) is a form of integration in which developers save the codes they develop in a repository of shared codes several times a day. During each code repository, an automated compilation tool checks the deposited code to ensure that there are no errors and that it is ready for production. This allows an early detection of errors.

The development teams can consequently provide a code containing few or no errors at a faster pace. A code containing few errors means faster validation, versions of the developed application comprising fewer errors, and therefore a more efficient development workflow easier to scale.

Continuous delivery (CD), for its part, follows continuous integration and can be considered as a control phase in the development workflow, before the final version of the application is published or deployed. Once the code modifications are validated, they are automatically delivered.

With continuous delivery, the objective is to keep modification sets small enough so that no update to the main version of the application will compromise the status of the final application if it is not ready for publication. Continuous delivery allows the developers to spend less time on internal testing, as it aims to guarantee that only a stable code, that is to say a code containing few or no errors, reaches the delivery phase.

In other implementations, when the obtained information relating to at least one development environment corresponds to a development environment not listed in the digital passport, the method comprises:
creating a new entry corresponding to this new environment in said digital passport.

This is for example the case when the operating system of at least one hardware component used during the development of the application is changed, or when one of the hardware components used during the development of the application is changed.

When a new version of an application is developed, a digital passport dedicated to it is created. This allows simplified access to the data relating to each version of the same application.

In particular implementations, the obtained information relating to said at least one development environment is time-stamped and signed using a cryptographic key of said monitoring entity.

This guarantees their authenticity and their integrity.

In particular implementations, a method according to embodiments of the disclosed technology comprises:
determining a digest of the information relating to at least one development environment comprised in at least one of said entries of said digital passport.

Such a digest is the result of the application of a hash function to all the information comprised in an entry of the digital passport. Indeed, a hash function makes it possible to assign to data of variable and arbitrary size indices associated with a fixed-size array. In other words, a hash function is a mathematical function that associates fixed-size values with data of any size.

The use of a hash function as part of the storage and indexing of data allows accessing them in a reduced time while requiring a reasonable storage space relative to the volume of data to be stored.

In particular implementations, said digest is time-stamped and signed using a cryptographic key of said electronic device.

This guarantees its authenticity and its integrity.

In particular implementations, the digest is transmitted to at least one node contributing to a shared register.

By shared register is meant a memory register, such as one or more servers or a partition of a memory disk, etc., that can be decentralized in order to facilitate access. Such a shared register can further be a register called immutable register because once information has been entered in this register, it cannot be deleted by anyone. If information entered in this register needs to be modified, such a modification is the subject of a new entry in the immutable register. Thus, such an immutable register contains the history of all the exchanges that have been entered therein since its creation.

In order to guarantee the immutability of such a register, it is for example possible to lock the memory areas containing information for writing. It is also possible to limit writing access to the register to a restricted number of trusted nodes, etc. Reading access to the immutable register can also be restricted to a limited number of nodes.

One example of such an immutable register is a blockchain.

The blockchain is a technology for storing and transmitting information that is transparent, secure and runs without a central control body. More especially, a blockchain is a distributed database that contains the history of all the exchanges made between its users since its creation: the information sent by the users and the exchanges internal to the database are verified and grouped at regular intervals into blocks, thus forming a chain. The whole is secured by cryptography.

More precisely, the transactions made between users of the network of nodes contributing to a blockchain are grouped into blocks. In the field of blockchains, a transaction is an action recorded in a blockchain that changes its state. One example of a transaction might be the transfer of an amount in cryptocurrency from one account to another or the entry of positioning data of a user device. Each block is validated by the nodes of the network, following cryptographic techniques that depend on the type of blockchain used. Once the block is validated, it is time-stamped and added to the blockchain, to which all users have access. The transaction is then visible to all the nodes of the network. Once added to the blockchain, a block can no longer be modified or deleted, which guarantees the authenticity and security of the network.

There are public blockchains, open to all, and private or consortium blockchains, whose access and use are limited to a certain number of players defined in advance.

In particular implementations, an indicator relating to at least one of said information relating to at least one development environment is associated with said digest prior to said transmission.

In order to facilitate querying of the shared register, the digest may for example be associated with an indicator relating to at least one of said information relating to at least one development environment.

For example, such an indicator may be representative of a value of the electricity consumption relating to the development of the application or an indicator representative of a quantity of metals used during the manufacture of the hardware components used during the development of the application.

The aim of these indicators associated with the digest is to allow a player wishing to deploy an application to be able to select an application based on information that is important from his point of view.

In particular implementations, the method for generating a digital passport further comprises:
determining an indicator representative of energy consumption relating to the development of the application by means of at least one of said information relating to at least one development environment, said indicator representative of energy consumption being stored in said at least one corresponding entry.

Such an indicator, which may be a letter from A to G for example, represents a value of the electricity consumption for a given period, for example a year or an hour, of the development of the application. It may take into account, beyond the consumption of electrical energy, the quantity of water used during the manufacture and/or the recycling, or a quantity of other consumables such as plastic materials or paper, etc.

According to a second aspect, embodiments of the disclosed technology also relate to a method for selecting, by a first computer entity, at least one digital passport relating to an application intended to be deployed in at least one second computer entity, said digital passport comprising at least one entry comprising information relating to at least one environment, called development environment, in which said application is developed, comprising:
transmitting, to at least one node contributing to a shared register in which information relating to at least one digital passport is stored, a request to obtain a digital passport relating to a given application,
selecting at least one entry of said digital passport by means of at least one value of an indicator relating to at least one of said information relating to at least one development environment,
transmitting said information relating to at least one development environment comprised in the selected entry to at least one orchestration entity intended to deploy a production environment for said application based on said information relating to at least one development environment.

As a corollary, embodiments of the disclosed technology concern a computer entity comprising:
a transmission module configured to transmit a request to obtain a digital passport relating to an application intended to be deployed in at least one other computer entity, to at least one node contributing to a shared register in which information relating to at least one digital passport is stored, said digital passport comprising at least one entry comprising information relating to at least one environment, called development environment, in which said application is developed,
a selection module configured to select at least one entry of said digital passport by means of at least one value of an indicator relating to at least one of said information relating to at least one development environment,
a transmission module configured to transmit said information relating to at least one development environment comprised in the selected entry to at least one orchestration entity intended to deploy, select or update a production environment for said application based on said information relating to at least one development environment.

A player, such as a telecommunications operator, wishing to implement a packet routing application or a network function developed by a third party will be able to consult the shared register in which different digests of entries of different digital passports relating to one or more routing applications and their different versions are stored. Depending on the needs of this telecommunications operator and by means of the indicators associated with the different digests, he will be able to select a version of the application that meets his criteria.

For example, if for this telecommunications operator, it is important that the application can be put into production in a production environment in which the hardware components comprise at least 18% recycled copper and has an energy class A, he uses these two criteria to query the shared register.

Once in possession of one or more digests identifying digital passport entries that meet his expectations, the telecommunications operator can then deploy an appropriate production environment of which he already knows the energy performance thanks to the various information contained in the entry of the selected digital passport.

In one particular embodiment, methods according to embodiments of the disclosed technology are implemented by a computer.

In this respect, the disclosed technology also relates to a computer program on a recording medium, this program being capable of being implemented in a computer or more generally in an electronic device in accordance with the disclosed technology and including instructions adapted to the implementation of a method for generating a digital passport as described above.

The disclosed technology also relates to a computer program on a recording medium, this program being capable of being implemented in a computer or more generally in a computer entity in accordance with the disclosed technology and including instructions adapted to the implementation of a method for selecting a digital passport as described above.

Each of these programs can use any programming language, and be in the form of source code, object code or intermediate code between source code and object code, such as in a partially compiled form or in any other desirable form.

Embodiments of the disclosed technology also relate to an information medium or a recording medium readable by a computer, and including instructions of a computer program as mentioned above.

The information or recording medium may be any entity or device capable of storing the programs. For example, the medium may include a storage means such as a ROM for example a CD ROM or a microelectronic circuit ROM, or a magnetic recording means for example a hard disk or a flash memory.

On the other hand, the information or recording medium may be a transmissible medium such as an electrical or optical signal, which may be conveyed via an electrical or optical cable, by radio link, by wireless optical link or by other means.

The programs according to the disclosed technology may particularly be downloaded from an Internet-type network.

Alternatively, the information or recording medium may be an integrated circuit in which a program is incorporated, the circuit being adapted to execute or to be used in the execution of the methods according to the disclosed technology.

It may also be envisaged, in other embodiments, that the methods according to the disclosed technology, the electronic device and the computer entity according to the disclosed technology have in combination all or part of the aforementioned characteristics.

### BRIEF DESCRIPTION OF THE DRAWINGS

Other characteristics and advantages of the disclosed technology will emerge from the description given below, with reference to the appended drawings which illustrate one exemplary embodiment thereof without any limitation. In the figures:

FIG. 1 represents a system for generating and selecting a digital passport in which the methods according to embodiments of the disclosed technology are implemented;

FIG. 2 schematically represents the hardware architecture of a computer on which an LCM server and an application deployment management entity in accordance with the disclosed technology are based, belonging to the communication system of FIG. 1;

FIG. 3 illustrates, in the form of a flowchart, the main steps of the methods implemented by an LCM server and an application deployment management entity according to one exemplary implementation of the disclosed technology.

### DETAILED DESCRIPTION

The disclosed technology is based on the generation, for each version of a given application or software, of a digital passport comprising information relating to the environment in which it was developed. By application is meant any digital product or service running on an operating system. Thus, when speaking of application, it may be for example a word processing software, a streaming application for multimedia streams, a library intended to be called during the execution of the application, or software enabling deep packet inspection (DPI).

As mentioned previously, by software or application development environment within the meaning of the disclosed technology is meant the set of tools, hardware and/or software resources used by developers to generate, test and debug this software or application.

Such a development environment generally comprises: code editors, code compilers/interpreters, version managers, test tools, or debuggers. Finally, a development environment comprises servers, virtual machines, Docker or Kubernetes containers, etc., allowing the execution of the application under development.

The digital passport object of the present solution aims to provide, for a software or an application, transparent and reliable information regarding their origin, their composition, their environmental impact, their sustainability, their reusability in other environments in which it can be executed, as well as its environmental impact.

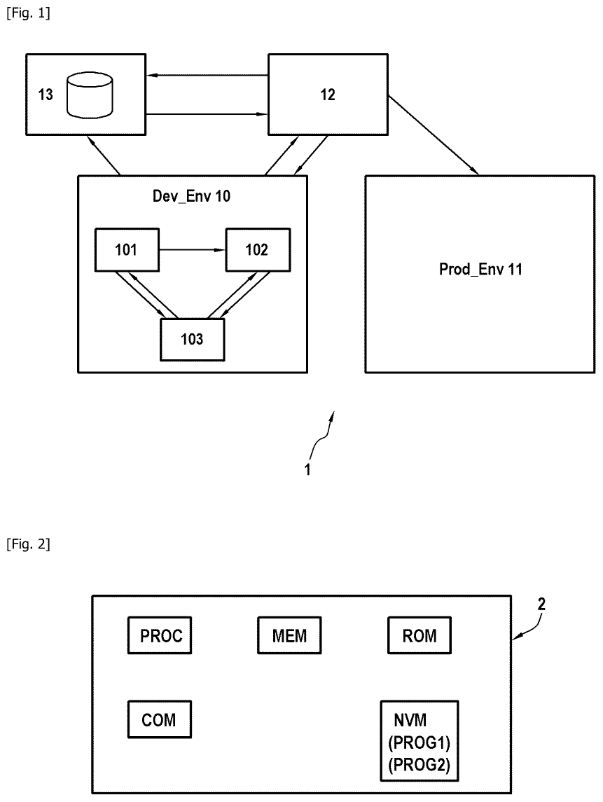

A system in which such a digital passport is generated and then used is described with reference to FIG. 1.

Such a system 1 comprises at least one application development environment 10, at least one production environment 11 for the applications developed in the development environment 10, at least one application deployment management entity 12 and at least one shared register 13. The interactions between these different entities 10, 11, 12 and 13 will be explained in more detail later in the document.

The development environment 10 comprises in particular, but not exclusively, a life cycle management server 101 or LCM (Life Cycle Management) server whose function is, among other things, to manage the life cycle of the computer systems, whether hardware or software, their provision, their operation and their decommissioning when they are obsolete.

The development environment 10 also comprises a cluster 102 of compute nodes or of work machines, these may be virtual machines that execute containerized applications. The containerization is an execution and software deployment process that groups together the code of an application with all the files and libraries it needs in order to be executed on any infrastructure. One example of such a cluster 102 is a Kubernetes cluster. Kubernetes is a container orchestration solution that allows managing, coordinating and scheduling containers at scale.

Finally, the development environment 10 comprises at least one monitoring entity 103 of the development environment 10.

The interactions between these different entities 101, 102, and 103 will be explained in more detail later in the document.

Just like the development environment 10, the production environment 11 may comprise an LCM server, a cluster of compute nodes and at least one monitoring entity. These constituent elements of the production environment 11 are not represented in the figures.

The development 10 and production 11 environments may also comprise user devices 101 such as smartphones, mobile phones, tablets or even connected objects such as connected vehicles in which one or more applications, for which a digital passport is generated in accordance with the disclosed technology, are intended to be executed.

The application deployment management entity 12 is for example a computer making it possible to interact with the development 10 and production 11 environments as well as with the shared register 13.

The shared register 13 may consist of one or more servers or a partition of a memory disk, etc. Such a shared register can be decentralized in order to facilitate access. Such a shared register 13 can further be a register called immutable register because once information has been entered into this register, it cannot be deleted by anyone. If information entered in this register needs to be modified, such a modification is the subject of a new entry in the immutable register. Thus, such an immutable register contains the history of all the exchanges that have been entered therein since its creation.

One example of such an immutable register is a blockchain. In such a case, the shared register 13 consists of a network of nodes contributing to a blockchain, comprising a plurality of nodes interconnected to each other.

It should be noted that the term node can correspond to a software component as well as to a hardware component or a set of hardware and software components, a software component itself corresponding to one or more computer programs or sub-programs or more generally to any element of a program able to implement a function or a set of functions.

In the embodiment described here, a node comprises a random-access memory (for example a RAM memory), a processing unit equipped for example with a processor and driven by a computer program, representative of the code instructions of one or more smart contracts, stored in a read-only memory (for example a ROM memory or a hard disk), and implementing a panel of functions necessary for certification of the data intended to be stored in the blockchain.

In the embodiment described here, the LCM server 101 and the application deployment management entity 12 have the hardware architecture of a computer 2 as illustrated in FIG. 2. This hardware architecture in particular comprises a processor PROC, a random-access memory MEM, a read-only memory ROM, a non-volatile memory NVM, and communication means COM allowing the LCM server 101 and the application deployment management entity 12 to communicate with each other and with the rest of the entities of the system 1 such as the shared register 13 and the entities 102 and 103. The non-volatile memory NVM constitutes a recording medium in accordance with the disclosed technology, readable by the processor PROC and on which one or more programs in accordance with the disclosed technology are recorded.

One of these programs, denoted PROG1 when the hardware architecture of the computer 2 is that of the LCM server 101, is recorded in the non-volatile memory NVM and includes instructions defining the main steps of a method for generating a digital passport relating to an application according to the disclosed technology as implemented by the LCM server 101. It defines more specifically the functional modules of the LCM server 101, which rely on and/or control all or part of the PROC, MEM, ROM, NVM and COM elements of the computer 2 cited above.

In the embodiment described here, the program PROG1 defines in particular the following functional modules of the LCM server 101:
a generation module configured to generate a digital passport relating to an application intended to be deployed in at least one computer entity,
a transmission module configured to transmit the digital passport to the shared register 13.

The operation of the constituent modules of the LCM server 101 is detailed further later with reference to the steps of the method for generating a digital passport relating to an application according to the disclosed technology.

The computer program recorded in the non-volatile memory NVM, when the hardware architecture of the computer 2 is that of the application deployment management entity 12, is denoted PROG2 and includes instructions defining the main steps of a method for selecting at least one digital passport relating to an application according to the disclosed technology as implemented by the application deployment management entity 12. It defines more specifically the functional modules of the application deployment management entity 12 which rely on and/or control all or part of the PROC, MEM, ROM, NVM and COM elements of the computer 2, cited above.

The program PROG2 defines in particular the functional modules of the application deployment management entity 12:
a transmission module configured to transmit a request to obtain a digital passport relating to an application to the shared register 13,
a selection module configured to select at least one entry of a digital passport,
a transmission module configured to transmit information relating to at least one development environment for a given application to at least one orchestration entity of the cluster 102 of compute nodes.

The operation of the modules of the application deployment management entity 12 is detailed further below with reference to the steps of the method for selecting at least one digital passport according to the disclosed technology.

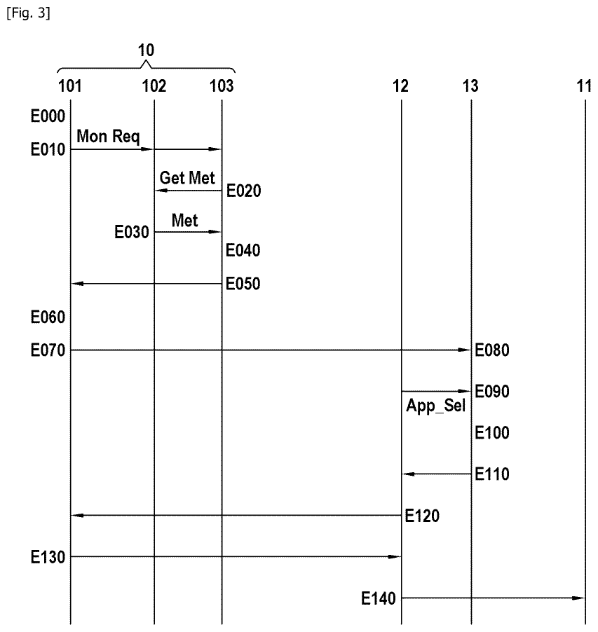

FIG. 3 illustrates, in the form of a flowchart, the main steps of a methods according to certain embodiments of the disclosed technology allowing the generation and the selection of a digital passport relating to an application intended to be deployed in at least one computer entity implemented by the LCM server 101 and by the application deployment management entity 12 according to one exemplary implementation of the disclosed technology.

As illustrated in FIG. 3, a first step E000 is implemented during which the server 101 of the development environment 11 creates a digital passport Pass-App1-V1 relating to a first version V1 of an application App1. This digital passport Pass-App1-V1 comprises at least one entry Pass-App1-V1-Ei.

Such an entry Pass-App1-V1-Ei comprises a plurality of information relating to the development environment 11 such as for example:
a value of the electricity consumption relating to the development of the application App1,
a value representative of the quantity of carbon generated by the development of the application App1,
a value representative of the quantity of water used during the manufacture of the hardware components used during the development of the application App1,
a quantity of metals used during the manufacture of the hardware components used during the development of the application App1,
a percentage of recycled metal for at least one of the metals used during the manufacture of said hardware components,
an identifier of at least one hardware component used during the development of the application App1,
an identifier of a version of at least one operating system of at least one hardware component used during the development of the application App1,
an identifier of at least one transport protocol supported by the application APP1,
an identifier of a version of a management system for the cluster 102 of compute nodes,
data relating to the commissioning of some equipment, or even
an estimated lifespan of the latter, etc.

Each of the information is grouped in a dedicated field of the entry Pass-App1-V1-Ei.

One example of such a digital passport Pass-App1-V1 comprising three entries App1-V1-E1, App1-V1-E2 and App1-V1-E3 is represented below.

| Pass-App1-V1 | E1 | E2 | E3 |
|---|---|---|---|
| App1r | App1-V1 | App1-V1 | App1-V1 |
| Equipment | Processor, | Processor, | Processor, |
| | RAM, Disk | RAM, Disk | RAM, Disk |
| Protocol QUIC | Y | Y | |
| Encryption AES | Y | N | NA |
| TCP offload engine | | | |
| Operating system | OS_1 + | OS_2 + | OS_n + |
| | core_1 | core_2 | core_n |
| Version K8S | 1.28 | 1.27 | 1.26 |
| CSR assessment/ | A | B | E |
| Energy class | | | |
| Recycled copper | Note_1 | Note_2 | Note_n |
| quantity (mg) | | | |
| Copper quantity | Note_1 | Note_2 | Note_n |
| (mg) | | | |
| Energy | Note_1 | Note_2 | Note_n |
| efficiency | | | |
| W/Tbits | | | |

In the digital passport example above, each entry Ei corresponds to a development environment in which the version V1 of the application App1 is developed. These different development environments are distinguished from each other for example by the use of a different processor or RAM memory, or by the use of a different operating system, etc.

Such a digital passport Pass-App1-V1 comprises ten fields in the chosen example; it can of course comprise more or fewer fields depending on the level of information one wishes it to contain. Thus, a digital passport in accordance with the disclosed technology can comprise information relating to all the hardware components constituting the servers and the other computer entities involved in the development of the application App1.

More especially, the digital passport Pass-App1-V1 comprises:
a first field in which information relating to the hardware components, such as processors, memories, etc. of the constituent equipment a development environment, is stored,
a second field indicating whether the QUIC protocol is supported by the application App1-V1 for exchanging data (Y for yes and N for no),
a third field indicating whether the AES encryption protocol is supported by the application App1-V1 for exchanging data (Y for yes, N for no, NA for not applicable),
a fourth field indicating whether the TCP offload engine is supported by the application App1-V1 (Y for yes and N for no),
a fifth field indicating the version of the operating system used,
a sixth field indicating the version of the Kubernetes solution used,
a seventh field comprising a value of the CSR (Corporate Social Responsibility) assessment and/or of the energy class of the application App1-V1, this value can range from A to E and represents the energy consumption in kilowatt x hours or kWh for a given duration of use,
an eighth field comprising a quantity, in milligrams or mg, of recycled metal or rare material (in the chosen example, copper) comprised in all the components of the development environment,
a ninth field comprising a quantity, in milligrams or mg, of metal or rare material (in the chosen example, copper) comprised in all the components of the development environment, and finally
a tenth field comprising information relating to the energy efficiency of the application App1-V1 given in Watts per terabit or W/Tbits.

It should be noted that the digital passport Pass-App1-V1 thus described concerns a version V1 of the application App1 and groups together information concerning the different development environments in which this version V1 of the application App1 was developed.

Thus, when developing a second version V2 of the application App1, a corresponding digital passport Pass-App1-V2 is created, this digital passport Pass-App1-V2 also comprising as many entries Pass-App1-V2-Ei as there are development environments in which this second version V2 of the application App1 was developed.

In other implementations of the disclosed technology, a single digital passport Pass-App1 groups together all the information relating to all the versions of the application App1 that were developed.

One example of such a digital passport Pass-App1 comprising three entries App1-V1-E1, App1-V1-E2 and App1-V2-E1 is represented below.

| Pass-App1-V1 | E1 | E2 | E1 |
|---|---|---|---|
| App1r | App1-V1 | App1-V1 | App1-V2 |
| Equipment | Processor, | Processor, | Processor, |
| | RAM, Disk | RAM, Disk | RAM, Disk |
| Protocol QUIC | Y | Y | |
| Encryption AES | Y | N | NA |
| TCP offload engine | | | |
| Operating system | OS_1 + | OS_2 + | OS_n + |
| | core_1 | core_2 | core_n |
| Version K8S | 1.28 | 1.27 | 1.26 |
| CSR assessment/ | A | B | E |
| Energy class | | | |
| Recycled copper | Note_1 | Note_2 | Note_n |
| quantity (mg) | | | |
| Copper quantity | Note_1 | Note_2 | Note_n |
| (mg) | | | |
| Energy | Note_1 | Note_2 | Note_n |
| efficiency | | | |
| W/Tbits | | | |

The pieces of information comprised in the digital passport are, for some of them, like the value representative of the quantity of water used during the manufacture of the hardware components, the quantity of metals used during the manufacture of the hardware components or the percentage of recycled metal for at least one of the metals used during the manufacture of said hardware components, provided by the manufacturers of these different hardware components, others pieces of information are measured and/or calculated throughout the development of the application App1 and are specific to the version and to the development environment for the application App1. This is in particular the case of information relating to the energy efficiency of the application App1-V1 given in Watts per terabit or W/Tbits or the energy class.

Once the development environment 10 has been deployed and the information provided by the manufacturers of the hardware and software components of the equipment constituting this development environment 10 has been obtained, the LCM server 101 transmits a monitoring request MonReq of the various equipment constituting the development environment 10 to the monitoring entity 103 in a step E010. It should be noted that the transmission of the monitoring request MonReq is not conditional on obtaining the information provided by the manufacturers of the hardware and software components of the constituent equipment of the development environment 10, the information being able to be obtained at any time but prior to the execution of step E060.

Upon receipt of this monitoring request MonReq, the monitoring entity 103 (step E020) broadcasts a data collection request GetMet to the equipments constituting the development environment 10 and more especially to the compute nodes of the cluster 102. The data intended to be collected concern for example the energy consumption, the level of use of the processors, the energy efficiency, etc.

Depending on the implementations, the monitoring entity 103 broadcasts data collection requests GetMet periodically or non-periodically.

Upon receipt of a data collection request GetMet, the equipments constituting the development environment 10 collect the information indicated in the data collection request GetMet.

Such equipment of the cluster 102 constituting the development environment 10 then transmits the collected data to the monitoring entity 103 in messages Met (E030).

These messages Met may be emitted periodically. In another implementation, the transmission of a message Met to the monitoring entity 103 may be triggered by the occurrence of an event such as for example a variation in a value of electrical energy consumed beyond a certain threshold. In some implementations, for a same equipment constituting the development environment 10, some messages Met may be transmitted periodically and others when a given event has occurred.

In order to guarantee the authenticity and the integrity of the collected data, each constituent equipment of the development environment 10 may, in one particular implementation of the disclosed technology, sign the message Met intended to be transmitted to the monitoring entity 103 by means of an encryption key. The collected data may also be time-stamped.

The monitoring entity 103 receives the various messages Met transmitted by the various equipments constituting the development environment 10 (E040) and transmits the collected data to the LCM server 101 (E050).

In one particular implementation, the monitoring entity 103 aggregates all the collected data and transmits them to the LCM server 101 during a single transmission. In another implementation, the monitoring entity 102 transmits the collected data following the receipt of each message Met. Regardless of the implementation chosen, the monitoring entity 103 can sign the data intended to be transmitted to the LCM server 101 using an encryption key in order to guarantee the authenticity and the integrity of these data.

In one particular implementation of a solution in accordance with certain embodiments of the disclosed technology, the monitoring entity 103 can determine, prior to transmission to the LCM server 101, a value of information to be transmitted. Thus, the monitoring entity 103 can determine a value of the energy efficiency using all the data collected by the various equipments constituting the development environment 10 and transmit only this overall value to the LCM server 101.

Similarly, the monitoring entity 103 can determine, prior to transmission to the LCM server 101, the value of the energy class of the application App1 using all the data collected by the various equipments constituting the development environment 10. Such a determination of a value of the energy class of the application App1 can be implemented by means of a neural network trained for such a purpose.

In another particular implementation of a solution according to an embodiment of the disclosed technology, it is the LCM server 101 itself that determines for example a value of the energy efficiency using all the data transmitted by the monitoring entity 103.

Similarly, the LCM server 101 can determine the value of the energy class of the application App1 using the data transmitted by the monitoring entity 103. Such a determination of a value of the energy class of the application App1 can be implemented using a neural network trained for this purpose.

Once in possession of all the necessary information, the LCM server 101 completes the digital passport Pass-App1-V1 by storing the information in the appropriate fields of the corresponding entry Ei.

In a step E060, the LCM server 101 determines a digest of the digital passport Pass-App1-V1. In another implementation, a digest is determined for each entry Ei of the digital passport Pass-App1-V1.

These digests are then transmitted (E070) to the shared register 13 in which they are stored (E080).

The digital passports and the corresponding digests are stored in the LCM server 101 or in another dedicated equipment. The LCM server 101 or the dedicated equipment can be securely queried by a third party wishing to access the content of a digital passport as will be explained later.

In order to facilitate searching in the shared register 13, the digests transmitted by the LCM server 101 are associated with indicators relating to one or more fields of the digital passport. Thus, the digest 6FE42C8DFE42CC8DFE of the entry Pass-App1-V1-E1 is associated with a CSR indicator identifying the seventh field of the digital passport comprising the energy class of the application App1-V1. Thus the following information: CSR_Class A_6FE42C8DFE42CC8DFE is transmitted to and stored in the shared register 13.

It is then possible to query the shared register 13 using different indicators, such as the energy class, the quantity of recycled copper, the energy efficiency, etc. in order to obtain one or more digital passports meeting the chosen selection criteria.

Steps E010 to E080 can be implemented throughout the development of the application App1, so the shared register 13 contains a history of all the developments of the application App1. This makes it possible to determine the compatibility of a version of a given application with a production environment consisting of previous generation equipments used during the development. This backward compatibility information is of particular interest in the framework of the circular economy because it contributes to making the use of reconditioned or second-hand equipment attractive, thus giving it a second life.

With each modification made to the application or to one of the equipment constituting the development environment, a new entry is created in an existing digital passport or a new digital passport is created.

In a step E090, the shared register 13 receives a request App-Sel to select a digital passport for a given application. Such a selection request App-Sel may be issued by the application deployment management entity 12 or by an equipment belonging to one individual wishing to install an application in one of their user terminals. For this purpose, the selection request App-Sel comprises an identifier of the application and possibly an indicator, such as the energy class or an identifier of an operating system or a version of an operating system, or even information relating to the hardware of the individual's user terminal, or a version of the application already installed and for which an update is required, etc.

Upon receipt of this selection request App-Sel, the shared register 13 identifies one or more digital passports or one or more entries of the same digital passport that satisfy the selection criteria comprised in the selection request App-Sel (E100).

Once the digital passport(s) have been selected, the shared register 13 transmits the corresponding digests to the application deployment management entity 12 (E110). Once in possession of the digests, the application deployment management entity 12 can query (E120) the LCM server 1010 or any other equipment in which the digital passports are stored in order to obtain (E130) a copy of the selected digital passports.

When it is in possession of the information comprised in the digital passports of which it has obtained a copy, the application deployment management entity 12 can then (E140) be deployed in a production environment 11 compliant with the development environment 10 corresponding to the entry of the selected digital passport, or updated to be brought into compliance with this development environment 10. Such a production environment compliant with the development environment 10 can also be deployed specifically for the execution of this application App1. The application App1 will then have the same behavior in this production environment 11 as the one it had in the corresponding development environment 10. In the case where the selection request is issued by an individual's equipment, the application deployment management entity 12 updates the user terminal as required in the request.

What is claimed is:

1. A method for generating, by an electronic device, at least one digital passport relating to an application intended to be deployed in at least one computer entity, the method comprising generating said digital passport, said digital passport comprising at least one entry comprising information relating to at least one development environment in which said application is developed.

2. The method of claim 1, further comprising:
obtaining said information relating to said at least one development environment from at least one monitoring entity of said at least one development environment.

3. The method of claim 2, wherein said information relating to said at least one development environment is obtained in a response to transmission, by said electronic device, of a request for information relating to a development environment.

4. The method of claim 3, further comprising:
adding said information relating to said at least one development environment in said at least one corresponding entry of the digital passport.

5. The method of claim 2, further comprising, in response to a determination that the obtained information relating to at least one development environment corresponds to a new development environment not listed in the digital passport:
creating a new entry corresponding to this new environment in said digital passport.

6. The method of claim 1, wherein the information relating to said at least one development environment belongs to a group comprising at least:
a value of the electricity consumption relating to the development of the application,
a value representative of the quantity of carbon generated by the development of the application,
a value representing the quantity of water used during the manufacture and/or the cooling and/or the recycling of the hardware components used during the development of the application,
a list of metals used during the manufacture of the hardware components used during the development of the application,
a quantity of metals used during the manufacture of the hardware components used during the development of the application,
a percentage of recycled metal for at least one of the metals used during the manufacture of said hardware components,
an identifier of at least one hardware component used during the development of the application,
an identifier of a version of at least one operating system for at least one hardware component used during the development of the application,
an identifier of at least one transport protocol supported by the application, an identifier of a version of a compute node management system executing the application.

7. The method of claim 1, further comprising:
determining a digest of the information relating to at least one development environment comprised in at least one of said entries of said digital passport.

8. The method of claim 7, further comprising:
transmitting said digest to at least one node contributing to a shared register.

9. The method of claim 8, wherein an indicator relating to at least one of said information relating to at least one development environment is associated with said digest prior to said transmission.

10. The method of claim 9, further comprising:
determining an indicator representative of energy consumption relating to the development of the application by means of at least one of said information relating to at least one development environment, said indicator representative of energy consumption being stored in said at least one corresponding entry.

11. A method for selecting, by a first computer entity, at least one digital passport relating to an application intended to be deployed in at least one second computer entity, said digital passport comprising at least one entry comprising information relating to at least one development environment in which said application is developed, the method comprising:
transmitting, to at least one node contributing to a shared register in which information relating to at least one digital passport is stored, a request to obtain a digital passport relating to a given application,
selecting at least one entry of said digital passport by means of at least one value of an indicator relating to at least one of said information relating to at least one development environment,
transmitting said information relating to at least one development environment comprised in the selected entry to at least one orchestration entity intended to deploy a production environment for said application based on said information relating to at least one development environment.

12. A non-transitory computer-readable data medium on which is stored program code instructions which, when executed by a processor of by an electronic device, causes the electronic device to generate at least one digital passport relating to an application intended to be deployed in at least one computer entity, said digital passport comprising at least one entry comprising information relating to at least one development environment in which said application is developed.

13. A non-transitory computer-readable data medium on which is stored program code instructions which when executed by a processor of a computer entity, causes the computer entity to:
transmit, to at least one node contributing to a shared register in which information relating to at least one digital passport is stored, a request to obtain a digital passport relating to a given application,
select at least one entry of said digital passport by means of at least one value of an indicator relating to at least one of said information relating to at least one development environment, and
transmit said information relating to at least one development environment comprised in the selected entry to at least one orchestration entity intended to deploy a production environment for said application based on said information relating to at least one development environment.

14. An electronic device comprising at least one processor configured for:
generating at least one digital passport relating to an application intended to be deployed in at least one computer entity, said digital passport comprising at least one entry comprising information relating to at least one environment, called development environment, in which said application is developed, and
transmitting said digital passport to at least one node contributing to a shared register in which information relating to a plurality of digital passports relating to applications intended to be deployed in at least one other computer entity is stored.

15. A computer entity comprising at least one processor configured for:
transmitting a request to obtain a digital passport relating to an application intended to be deployed in at least one other computer entity, to at least one node contributing to a shared register in which information relating to at least one digital passport is stored, said digital passport comprising at least one entry comprising information relating to at least one environment, called development environment, in which said application is developed,
selecting at least one entry of said digital passport by means of at least one value of an indicator relating to at least one of said information relating to at least one development environment, and
transmitting said information relating to at least one development environment comprised in the selected entry to at least one orchestration entity intended to deploy, select or update a production environment for said application based on said information relating to at least one development environment.
